(19) United States
(12) Patent Application Publication
(10) Pub. No.: US 2015/0236952 A1
(43) Pub. Date: Aug. 20, 2015

(54) VIRTUAL PRIVATE LAN SERVICE BASED EDGE ROUTER

(71) Applicant: Alcatel Lucent, Paris (FR)

(72) Inventors: Zheng Liang, Shanghai (CN); Fanxiang Bin, Shanghai (CN)

(21) Appl. No.: 14/428,477

(22) PCT Filed: Aug. 23, 2013
(86) PCT No.: PCT/IB2013/002232

§ 371 Date: Mar. 16, 2015

(30) Foreign Application Priority Data
Sep. 29, 2012 (CN) 201210379346.8

(51) Int. Cl. H04L 12/713; H04L 29/12; H04L 12/801; H04L 12/46

(52) U.S. Cl. CPC H04L 45/586; H04L 12/4641; H04L 61/6022; H04L 47/12

(57) ABSTRACT

In an embodiment, an edge router is interconnected with a second edge router and the two edge routers respectively provide accesses to the communication network for a first device and a second device. The method includes, when a message containing a MAC address of the first device as a L2 source address and an IP address of the second device as a L3 target address from the first device is received, converting the L2 source address of the message into a virtual MAC address of the first device; and sending a message having the virtual MAC address of the first device to the second edge router according to the IP address of the second device. The virtual MAC address of the first device contains information PEID identifying the edge router, information VMID identifying the first device and information VIDCA for, in case that there may be a collision when identifying the first device, collision avoidance.

### TECHNICAL FIELD

The present invention relates to the communication field, in particular, to a virtual private LAN service (VPLS) based router.

### DESCRIPTION OF THE RELATED ART

Cloud computing is an attractive model for providing efficient, on-demand, and cost-effective computing services to businesses, organizations or individuals. As known, virtual machines are the basic computing resource blocks being provided by cloud services.

Each VM operates as an independent IP host with a set of Virtual Network Interface Cards (vNICs), each having its own MAC address and mapping to a physical Ethernet interface. Recently, it is acknowledged that running all virtual machines and physical servers in different data centers over a single LAN (i.e., within the same subnet) can result in lots of benefits, such as, simplified virtual machine management, and flexible virtual machine migration, see Cisco, “Data Center Interconnect: Layer 2 Extension Between Remote Data Centers”. Today, VPLS has been widely regarded as a key technology to provide transparent LAN service (TLS) over IP/MPLS infrastructure. FIG. 1 shows a general architecture for cloud networking on a single large L2 network based on VPLS services.

Today, using virtualization technologies, a single physical host/server is now able to support 10s to 100s of virtual machines, see Igor Gashinsky, “Data Center Scalability Panel”, http://www.nanog.org/meetings/nanog52/presentations/Tuesday/Gashinsky-3-Y-Datacenter-s calability.pdf, Jun. 14, 2010, so that the number of virtual machines in one data center can be up to 1M˜10M (i.e., 10˜100 times of physical hosts/servers). It is conceivable that the number can be much higher in the future. Such large number indicates significant increases in both the size and density of the L2 cloud network. As known, large and flat LANs suffer from severe scaling challenges, see Girish Chiruvolu, et al., “Issues and Approaches on Extending Ethernet Beyond LANs,” IEEE Communications Magazine, March 2004. This invention intends to solve following specific technical problems in VPLS-based cloud networking.

Problem 1: MAC address and forwarding table explosion on provider edge router. Large number of virtual machines indicates a large amount of MAC addresses and forwarding entries. Assume that the number of interconnected data centers is N, and each of them has M virtual machines. As shown in FIG. 1, the MAC forwarding entry number of each VPLS PE is at least N×M. Table 1 shows typical numbers of MAC addresses and forwarding entries in provider edge router's MAC forwarding table. For example, Row 1 (2) shows the scenario that one service instance is provisioned via one data center, running with 1M (10M) virtual machines. Row 3 (4) shows the scenario that one service instance is jointly provisioned via 5 data centers, each running with 1M (10M) virtual machines. It shows that the numbers of MAC addresses and forwarding entries range from 1M-50M. They have overwhelmed the capacity of a state-of-the-art Ethernet switch, which supports 4K-100K MAC addresses and forwarding rules.

TABLE 1
Number of MAC addresses and forwarding
entries on flat L2 network

| | No. of MAC | No. of MAC forwarding |
|---|---|---|
| DC Sites per service | addresses per DC | entries per VPLS PE |
| instance (N) | GW (M) | (N × M) |
| 1 | 1,000,000 | 1,000,000 |
| 1 | 10,000,000 | 10,000,000 |
| 5 | 1,000,000 | 5,000,000 |
| 5 | 10,000,000 | 50,000,000 |

Problem 2: Encapsulation overhead due to MAC address stacking.

Recently, some proposed solutions utilize MAC address stacking, or say, MAC-in-MAC encapsulation to address Problem 1. This approach does reduce the numbers of MAC addresses and forwarding entries on provider edge router. However, MAC address stacking results in 20 bytes encapsulation overhead. Considering the large number of virtual machines in cloud networking element, the accumulated overhead accounts for considerable additional traffic.

The best existing solution of this problem is MAC address stacking by the first hop switches, which are directly connected to virtual machines or hosts/servers. The major drawback of this solution is: not available to legacy deployment of data centers. This solution requires the first hop switch to be compliant with IEEE 802.1ah to carry out the MAC address stacking. However, it is not safe to say that all the existing data centers have met the requirement. In reality, few data center switches, if any, are capable of supporting 802.1ah. Therefore, this solution is invalid to common data center deployment cases.

In total, the present invention seeks to find a solution for solving the problem of processing address and forwarding table explosion without an encapsulation overhead.

### SUMMARY OF THE INVENTION

This invention proposes a virtual MAC based solution for addressing the aforementioned technical problems in L2 domain cloud networking.

According to a first aspect, the invention sets forth a method for processing messages on an edge router of a VPLS based communication network, the edge router being interconnected with a second edge router, the edge router and the second edge router respectively providing accesses to the communication network for a first device and a second device, the method comprising: when a message containing a MAC address of the first device as a L2 source address and an IP address of the second device as a L3 target address from the first device is received, converting the L2 source address of the message into a virtual MAC address of the first device; and sending a message having the virtual MAC address of the first device to the second edge router according to the IP address of the second device, wherein the virtual MAC address of the first device contains information PEID identifying the edge router, information VMID identifying the first device and information VIDCA for, in case that there may be a collision when the first device is identified, collision avoidance.

According to an embodiment of the present invention, if the message is an Address Resolution Protocol (ARP) request message, the first device is a virtual machine and the second device is a virtual machine or a cloud customer device; and if the message is an ARP response message, the first device is a virtual machine or a cloud customer device and the second device is a virtual machine.

According to an embodiment of the present invention, the information identifying the edge router is obtained from specific fields of network interface card of the MAC addresses of the edge router or obtained from the IP address of the edge router.

In a preferable embodiment of the present invention, it comprises converting the source address of the message into the virtual MAC address of the first device according to an uMAC-vMAC mapping table stored in the edge router.

According to a second aspect, the invention sets forth a method for transmitting data packets on an edge router of a VPLS based communication network, the edge router being interconnected with a second edge router, the edge router and the second edge router respectively providing accesses to the communication network for a first device and a second device, the method comprising:

When a first data packet whose source address is a MAC address of the first device and target address is a virtual MAC address of the second device from the first device is received, converting the source address of the first data packet into a virtual MAC address of the first device; and

When a second data packet whose source address is a virtual MAC address of the second device and target address is a virtual MAC address of the first device from the second device is received, converting the target address of the second data packet into a MAC address of the first device,

Wherein, the virtual MAC address of the first device contains information PEID identifying the edge router, information VMID identifying the first device and information VIDCA for, in case that there may be a collision when identifying the first device, collision avoidance, and

The virtual MAC address of the second device contains information PEID identifying the second edge router, information VMID identifying the second device and information VIDCA for, in case that there may be a collision when identifying the second device, collision avoidance.

According to an embodiment of the present invention, it further comprises: determining an output port of the first data packet according to the PEID information in the virtual MAC address of the second device, and determining an output port of the second data packet according to the PEID information in the virtual MAC address of the first device.

According to a preferable embodiment of the present invention, the source address of the first data packet is converted into the virtual MAC address of the first device and the target address of the second data packet into the MAC address of the first device according to the uMAC-vMAC mapping table stored in the edge router.

According to a third aspect, the invention sets forth an edge router for processing a message in a VPLS based communication network, the edge router being interconnected with a second edge router, the edge router and the second edge router respectively providing accesses to the communication network for a first device and a second device, the edge router comprising: a source address converting module configured to, when a message containing a MAC address of the first device as a L2 source address and an IP address of the second device as a L3 target address from the first device is received, convert the source address of the message into a virtual MAC address of the first device, and a message transmitting module configured to transmit the message having the virtual MAC address of the first device to the second edge router according to the IP address of the second device, wherein, the virtual MAC address of the first device contains information PEID identifying the edge router, information VMID identifying the first device and information VIDCA for, in case that there may be a collision when identifying the first device, collision avoidance.

According to a fourth aspect, the invention sets forth an edge router for transmitting data packets in a VPLS based communication network, the edge router being interconnected with a second edge router, the edge router and the second edge router respectively providing accesses to the communication network for a first device and a second device, the edge router comprising: a first MAC address converting module configured to, when a first data packet containing a source address being a MAC address of the first device and a target address being a virtual MAC address of the second device from the first device is received, convert the source address of the first data packet into a virtual MAC address of the first device, and a second MAC address converting module configured to, when a second data packet containing a source address being a virtual MAC address of the second device and a target address being a virtual MAC address of the first device from the second device is received, convert the target address of the second data packet into a MAC address of the first device, wherein, the virtual MAC address of the first device contains information PEID identifying the edge router, information VMID identifying the first device and information VIDCA for, in case that there may be a collision when identifying the first device, collision avoidance, and the virtual MAC address of the second device contains information PEID identifying the second edge router, information VMID identifying the second device and information VIDCA for, in case that there may be a collision when identifying the second device, collision avoidance.

First, this invention greatly reduces the MAC address and forwarding table sizes on VPLS PE routers. Since all the virtual MAC addresses with the same PEID value share one forwarding entry, the forwarding table for inter VPLS PE communication can be reduced to the form as shown in Table 2. Hence, the number of forwarding entries in such a table is equal to the number of different PEIDs, not the number of virtual MACs. Besides, VPLS PE needs to maintain an uMAC-vMAC mapping table for carrying out MAC frame forwarding to the virtual machines under itself. For numerical comparisons, assume that the data center number is 5, and each one holds 10,000,000 virtual machines. Traditional VPLS PE requires the forwarding table holds 50,000,000 entries. However, this invention enables the VPLS PE to maintain a forwarding table of 10,000,004 entries. It is seen that the forwarding table size is reduced by ˜80%. Moreover, the number of the MAC address to learn is also reduced by 80%.

Second, this invention does not require modifications or any upgrade on intermediate switches between provider's VPLS PE and virtual machines. Therefore, the proposed solution is applicable to existing data centers, and is able to protect the investment.

Moreover, this invention does not require MAC address stacking. Hence, it will not result in additional communication overhead. Moreover, this invention does not require MAC frame modifications on virtual machine or cloud customer. Furthermore, this invention does not lead to additional communication overhead in address request/response processes.

### BRIEF DESCRIPTION OF THE DRAWINGS

With reference to the following detailed description and the figures, illustrative embodiments of the invention will be understood more comprehensively. In the drawings, the same elements are indicated with the same reference signs, and the figures are provided only for illustrative purpose, so they cannot be construed as limiting the present invention. Wherein,

FIG. 1 shows an illustrational VPLS based L2 domain cloud networking environment 100;

FIG. 2 shows an illustrative encoding format of the locally unique virtual MAC address;

FIG. 3 illustrates an address resolution process for inter VPLS PE address request/response according to the present invention; and

FIG. 4 illustrates an embodiment for inter VPLS PE communication according to the present invention.

### DETAILED DESCRIPTION OF THE PREFERRED EMBODIMENT

Now, with reference to the figures, various illustrative embodiments of the invention will be described more comprehensively. It shall be pointed out that the specific structure and functional details disclosed hereby are only for describing illustrative embodiments. The illustrative embodiments may be embodied in various alternative forms but shall not be deemed as being limited to the embodiments described hereby. It shall be appreciated that those skilled in the art may conceive of various arrangements which embody the principle of the present invention and are within the range of the present invention listed in the claims and other equivalent forms, though the arrangements are not specified or described hereby explicitly.

It shall be appreciated, though various elements are described with the terms of “first” and “second” and so on, these elements shall be limited by the terms, for the terms are only employed to distinguish the elements from each other. For instance, in case of without departing from the scope of the illustrative embodiments, the first element may be named as a second element, and similarly, the second element may be named as a first element. As used in description of the present application, the term “and” may have meanings of connection and separation at the same time, and it includes a part of or all the combinations of one or more items in the associated item list. It shall be further appreciated, when being used hereby, the terms of “comprise”, “include”, “contain” and “have” specify that the characteristic, integer, step, operation, element and/or component exist, but it does not exclude that one or more other characteristics, integers, steps, operations, elements, components and/or groups composed thereof exist or are added. Furthermore, the descriptions in the embodiment concerning “a”, “an” and “another” must not indicate a single embodiment.

Unless otherwise defined, meanings of all the terms employed hereby (including technical and scientific terms) are totally the same with those understood by those skilled in the art of the illustrative embodiments. It shall be further pointed out, in some other alternative performing manners, functions/operations may occur not in the order as shown in the figures. For instance, two graphs which are shown as consecutive may in fact be executed basically at the same time; otherwise, in certain cases, the graphs may be executed in reverse order depending on the related functions/operations.

It shall be pointed out, the “MAC address” in the present application has a general meaning, which means the globally unique MAC address; the “virtual MAC address” specifically means the local virtual MAC address<PEID, VIDCA, VID>.

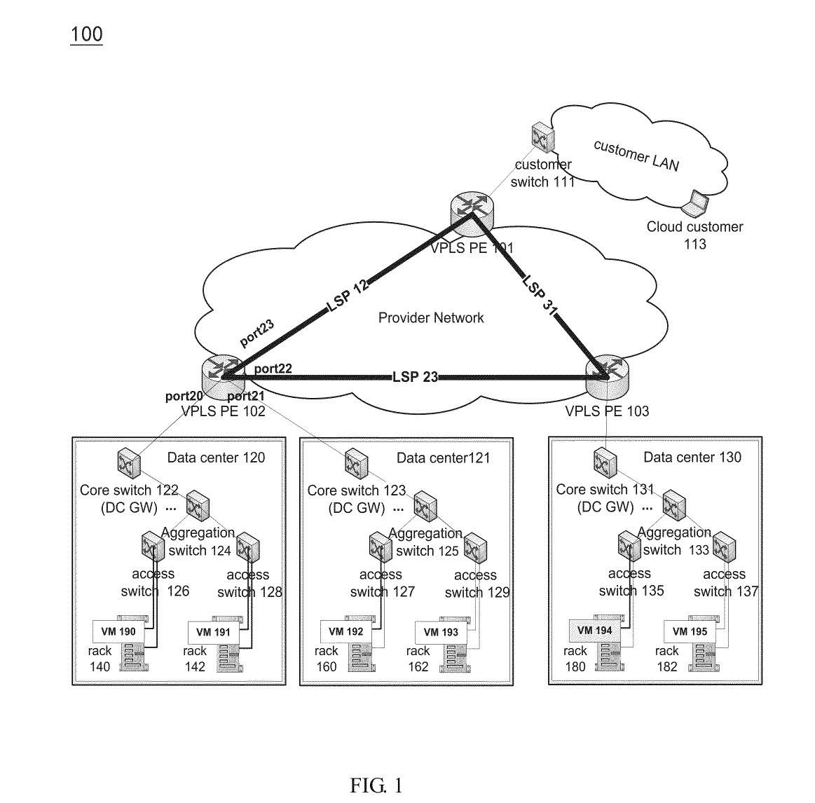

According to an embodiment of the present invention, FIG. 1 shows an illustrational VPLS based L2 domain cloud networking environment. VPLS PE 101 is connected to customer LAN with Customer Switch 111. Data Centers 120 and 121 are connected to VPLS PE 102. Data Center 130 is connected to VPLS PE 103. VPLS PEs 101, 102, and 103 are interconnected by means of LSPs.

Data Centers 120, 121, and 130 are of the same structure, and only Data Center 120 is elaborated as follows. In Data Center 120, Racks 140 and 142 host virtual machines. Racks 140 and 142 are respectively connected to Access Switches 126 and 128. The Access Switches provide connectivity directly to/from physical host/server and virtual machine. Access Switches 126 and 128 are connected to Aggregation Switch 124. In typical data center, aggregation switches can interconnect many Access Switches. Aggregation Switch 124 is then connected to Core Switch 122. Core Switch can connect multiple Aggregation Switches. Core Switch 122, connected to VPLS PE 102, also acts as Data Center 120's gateway to external provider network.

The inventor of the present application considers jointly encoding PE's and VM's identities into VM's locally unique virtual MAC <PEID, VIDCA, VID>. Virtual machine's locally unique virtual MAC includes 3 portions. The VID portion identifies the virtual machine. The VIDCA portion is for VID collision avoidance, if one VID associates to more than two virtual machines. The PEID identifies the VPLS PE router, which is connected to the core switch of the data center hosting the virtual machine.

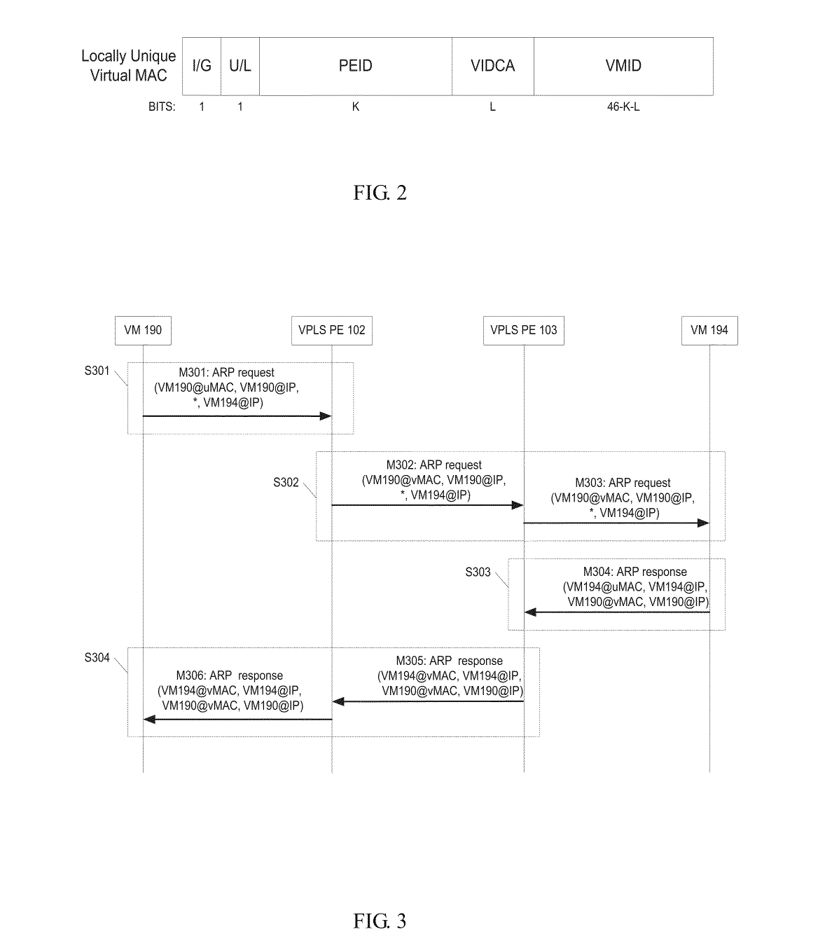

FIG. 2 shows an illustrative encoding format of the locally unique virtual MAC address.

In this example, each virtual machine will be allocated by VPLS PE with a locally unique virtual MAC, which can be expressed <PEID, VIDCA, VID>, where

(1) I/G: the Individual/Group address bit. Its value is set to 0 to indicate an individual address.

(2) U/L: the Universally/Locally administered address bit. Its value is set to 1 to indicate a locally administered address.

(3) PEID: a K-bit field identifying the VPLS PE, which is connected to the core switch of the data center hosting the virtual machine. A reference value of K can be 16, which can identify 65536 VPLS PEs for interconnecting the data centers.

Note: PEID can be based on multiple identification schemes. For example, PEID can be derived from the NIC (network interface card) specific field of VPLS PE's globally unique MAC. Also, PEID can be derived from the VPLS PE's IP address.

(4) VIDCA: an L-bit field using for VID collision avoidance. A reference value of L can be 6.

(5) VID: A (46-K-L)-bit field identifying virtual machine. A reference value of (46-K-L) can be 24, which can identify 16,777,216 virtual machines under administration.

Note: VID can be based on multiple identification schemes. For example, VID can be derived from the NIC specific field of virtual machine's globally unique MAC. Also, VID may be derived from the jointly information of virtual machine and its corresponding Access Switch.

There exist two cases regarding to VID collision. For example, the 1st one is: (as shown in FIG. 1) a virtual machine (e.g., VM 190) in Data Center 120 has the same VID of another virtual machine (e.g., VM 191) in the same Data Center. The 2nd one is: a virtual machine (e.g., VM 190) in Data Center 120 has the same VID of another virtual machine (e.g., VM 192) in Data Center 121. For both these 2 cases, the VID collision can be addressed by assigning different VIDCA values for the same VID. As an illustrative embodiment, VIDCA can include the information of Aggregation/Core switch, or Data Center.

It should be noticed that a virtual machine (e.g., VM 190) in Data Center 120 may have the same VID of another virtual machine (e.g., VM 194) in Data Center 130. Data Centers 120 and 130 are connected to different VPLS PEs (say, 102 and 103). Since VID only has local significance in terms of VPLS PEs, this case cannot be regarded as one case of VID collision.

Below, for inter VPLS PE communication, the source VPLS PE uses virtual MACs to respectively identify the source and target virtual machines. The target VPLS PE translates the virtual MAC of the target virtual machine into its globally unique MAC.

FIG. 3 illustrates the modified address resolution process for inter VPLS PE address request/response. In this embodiment ARP is only shown as one exemplary protocol. The modifications herein can be similarly to other protocols in different embodiments.

In Step 301, VM 190 sends M301 (an ARP request) to VPLS PE 102, with VM 190's globally unique MAC address (VM190@uMAC) as its source MAC address.

In Step 302, Upon receiving the ARP request M301, VPLS PE 102 sends M302 (an ARP request) to VPLS PE 103, with VM 190's locally unique virtual MAC address (VM190@vMAC), in place of VM 190's globally unique virtual MAC address (VM190@uMAC). Then, VPLS PE 103 sends M303 (an ARP request) to VM 194, with the same locally unique virtual MAC address (VM190@vMAC) as the source MAC address.

In Step 303, after receiving M303 (the ARP request), VM 194 sends M304 (an ARP response) to VPLS PE 103, with VM 194's globally unique MAC address (VM194@uMAC) as the MAC address to reach VM 194.

It is to be noticed that VM 194 can be aware that VM190@vMAC is associated with VM190@IP from the received ARP request packet M303.

In Step 304, upon receiving the ARP response M304, VPLS PE 103 sends M305 (an ARP response) to VPLS PE 102, with VM 194's locally unique virtual MAC address (VM194@vMAC), in place of VM 194's globally unique virtual MAC address (VM194@uMAC). Then, VPLS PE 102 sends M306 (an ARP response) to VM 190, with the same locally unique virtual MAC address (VM194@vMAC), as the MAC address to reach VM 194.

For inter VPLS PE address request/response, the source VPLS PE uses source virtual machine's virtual MAC in the request. The target VPLS PE uses target virtual machine's virtual MAC in the response. As a result, both globally unique MAC addresses of the source and target virtual machines are hidden by the VPLS PEs.

It should be noticed, in this invention, address resolution for intra VPLS PE address request/response is not affected. As an example, suppose that VM 190 intends to request VM 191's (or 193's) MAC address. VM 190 sends an ARP request to VPLS PE 102, with VM 190's globally unique MAC address (VM190@uMAC) as its source MAC address. VPLS PE 102 is aware that VM 191 (or 193) can be reached without crossing an inter VPLS PE LSP. Therefore, the source MAC address in the request will not be changed to VM 190's locally unique virtual MAC address (VM190@vMAC). Finally, an ARP reply will be sent back to VM 190. In the reply VM 191's (or 193's) MAC address is VM191@uMAC (or VM193@vMAC), say, a globally unique MAC address. It will not be changed to VM 191's (or 193's) locally unique virtual MAC address on VPLS PE 102.

An illustrative embodiment of the present invention provides the MAC address tables on VPLS PE. Following tables are in the context of VPLS PE 102.

Table 2 is an illustrated PEID table taking VPLS PE 102 as an example. This table records the PEIDs that are different to the PEID of VPLS PE 102, and their related ports. The table can be obtained from the inter VPLS PE address request/response. The values in the PEID column are derived from the PEID fields in virtual machine's locally unique virtual MAC addresses.

TABLE 2
PEID table of VPLS PE 102

| PEID | Port |
|---|---|
| PEID101 (for VPLS PE101) | port23 |
| PEID103 (for VPLS PE103) | port22 |

For example, PEID103 can be obtained from VM 194's (or 195's) locally unique virtual MAC address, that is, VM194@vMAC (or VM195@vMAC). In fact, all the target virtual machines that have the same PEID in their virtual MAC will share one common entry in the PEID table. For example, VMs 194 and 195 share the 2nd entry in the illustrated Table 2. It should be notice that the size of PEID table is not determined by the number of virtual machines under other VPLS PEs. Instead, the size of PEID table is determined by the number of the VPLS PEs connected to VPLS PE 102 through LSPs.

Table 3 is an illustrated uMAC-vMAC mapping table taking VPLS PE 102 as an example.

TABLE 3
uMAC-vMAC mapping table of VPLS PE 102

| VIDCA | VID | VM@uMAC | Port |
|---|---|---|---|
| 0 | VID1 | VM190@uMAC | port20 |
| 1 | VID1 | VM191@uMAC | port20 |
| 0 | VID2 | VM192@uMAC | port21 |
| 0 | VID3 | VM193@uMAC | port21 |

This table maintains the mapping relation between virtual machine's globally and locally unique virtual MAC addresses, say, uMAC and vMAC. It should be noticed that only the virtual machines under VPLS PE 102 should be considered in this mapping table. In addition, since these virtual machines' locally unique virtual MAC addresses have the same PEID as PEID102, the PEID value can be omitted in the mapping table. Consequently, only the VIDCA and VID fields are needed in the mapping between uMAC and vMAC. From Table 3, it can also be observed that if VID values are occasionally the same they can be further identified by the VIDCA values. Moreover, it should be noticed that the size of the uMAC-vMAC mapping table is determined by the number of virtual machines under VPLS PE 102.

It should be noticed that only the virtual machines under VPLS PE 102 should be considered in this mapping table. In addition, since these virtual machines' locally unique virtual MAC addresses have the same PEID as PEID102, the PEID value can be omitted in the mapping table. Consequently, only the VIDCA and VID fields are needed in the mapping between uMAC and vMAC. From Table 3, it can also be observed that if VID values are occasionally the same they can be further identified by the VIDCA values. Moreover, it should be noticed that the size of the uMAC-vMAC mapping table is determined by the number of virtual machines under VPLS PE 102.

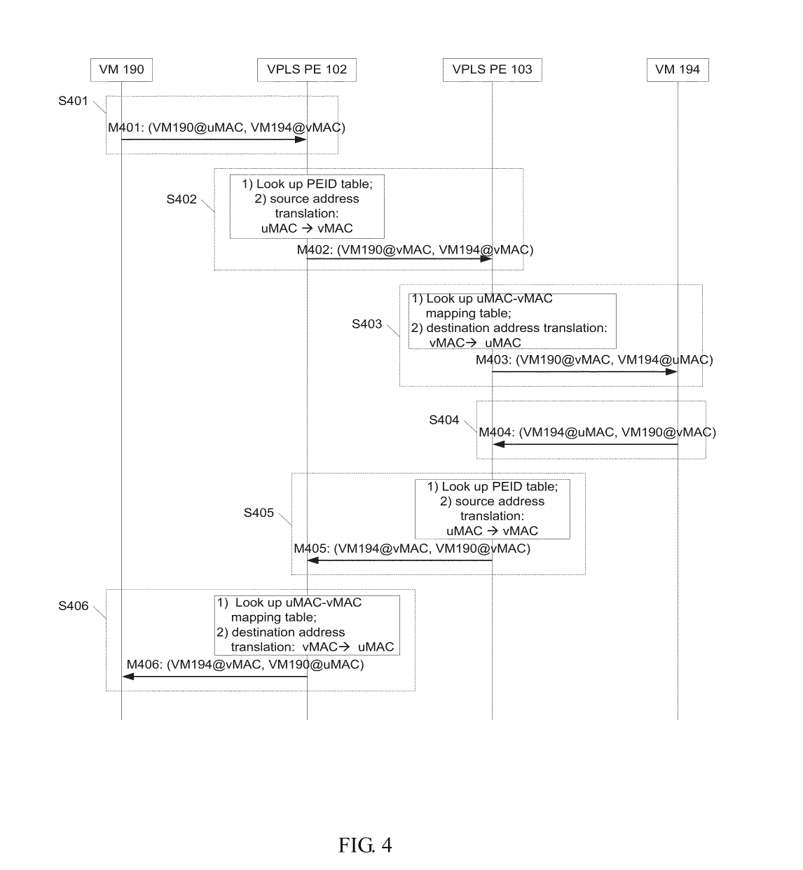

FIG. 4 illustrates the modified MAC frame forwarding for inter VPLS PE communication. As example, it is assumed that the communication peers are two virtual machines under different VPLS PEs. However, this illustration is also valid for the case that one of the communication peers is cloud customer.

In Step 401, VM 190 intends to send M401 (a unicast MAC frame) to VM 194. VM 190 gets VM194@vMAC as VM 194's data link layer address, for example its ARP cache after the modified address resolution process described in section 4. Consequently, M401's destination MAC address is set with VM194@vMAC. For conducting following steps, assume that VM194@vMAC is specifically expressed as <PEID103, VIDCA4, VID4>. In addition, VM 190 uses its globally unique MAC address VM190@uMAC as M401's source MAC address.

In Step 402, VPLS PE 102, on the unicast path from VM 190 to VM 194, intercepts the MAC frame M401. VPLS PE 102 is aware that M401 is a unicast MAC frame destined to a virtual machine not under itself, because its destination MAC address is a locally unique virtual MAC address, whose field is PEID103. By means of looking up its PEID table, VPLS PE 102 finds out that the target PE is VPLS PE 103. Then VPLS PE 102 sends M402 (a unicast MAC frame) to VPLS PE 103, with VM 190's locally unique virtual MAC address, say, VM 190@vMAC, as the source MAC address. For conducting following steps, assume that VM190@vMAC is further expressed as <PEID102, VIDCA1, VID1>.

In Step 403, upon receiving M402, VPLS PE 103 knows that it is the target PE from the destination MAC address's PEID field. VPLS PE 103 looks up its uMAC-vMAC mapping table and is aware that VM 194 is the destination. Then, VPLS PE 103 sends M403 (a unicast MAC frame) to VM 194, with VM 194's globally unique MAC address, say, VM194@uMAC, as the destination MAC address.

In Step 404, after receiving M403, VM 194 learns from this frame that VM 190's data link layer address is VM190@vMAC, which may further be stored into its ARP cache. When VM 194 intends to send M404 (a unicast MAC frame) to VM 190, it regards VM190@vMAC (more specifically, <PEID102, VIDCA1, VID1>) as the frame's destination MAC address.

In Step 405, VPLS PE 103, on the unicast path from VM 194 to VM 190, intercepts the MAC frame M404. VPLS PE 103 is aware that M404 is a unicast MAC frame destined to a virtual machine not under itself, because its destination MAC address is a locally unique virtual MAC address, whose field is PEID102. By means of looking up its PEID table, VPLS PE 103 finds out that the target PE is VPLS PE 102. Then VPLS PE 103 sends M405 (a unicast MAC frame) to VPLS PE 102, with VM 194's locally unique virtual MAC address, say, VM194@vMAC, as the source MAC address.

In Step 406, upon receiving M405, VPLS PE 102 knows that it is the target PE from the destination MAC address's PEID field. VPLS PE 102 looks up its uMAC-vMAC mapping table and consequently knows that VM 190 is the destination. Then, VPLS PE 102 sends M406 (a unicast MAC frame) to VM 190, with VM 190's globally unique MAC address, say, VM190@uMAC, as the destination MAC address.

For inter VPLS PE communication, the source VPLS PE determines the egress port of MAC frame based on the PEID portion of the target virtual machine's virtual MAC. The virtual MACs with the same PEID share one common forwarding entry, which reduces the size of forwarding table. Upon receiving the MAC frame, the target VPLS PE determines the egress port of the MAC frame based on the translated globally unique MAC of the target virtual machine.

It should be noticed, in this invention, MAC frame forwarding for intra VPLS PE communication is not affected. As an example, suppose that VM 190 intends to request VM 191's (or 193's) MAC address. VM 190 sends an ARP request to VPLS PE 102, with VM 190's globally unique MAC address (VM190@uMAC) as its source MAC address. VPLS PE 102 is aware that VM 191 (or 193) can be reached without crossing an inter VPLS PE LSP. Therefore, the source MAC address in the request will not be changed to VM 190's locally unique virtual MAC address (VM190@vMAC). Finally, an ARP reply will be sent back to VM 190. In the reply VM 191's (or 193's) MAC address is VM191@uMAC (or VM193@vMAC), say, a globally unique MAC address. It will not be changed to VM 191's (or 193's) locally unique virtual MAC address on VPLS PE 102.

As example, it is assumed that the communication peers are two virtual machines under the same VPLS PEs. However, the following illustration is also valid for the case that one of the communication peers is cloud customer. Suppose that VM 190 intends to send a unicast MAC frame to VM 192. The frame uses VM 190's globally unique MAC address (VM190@uMAC) as its source MAC address, and VM 192's globally unique MAC address (VM192@uMAC) as its destination MAC address. VPLS PE 102, on the unicast path from VM 190 to VM 192, intercepts the MAC frame. Since both the source and destination data link layer addresses are globally unique MAC addresses, VPLS PE 102 is aware that the frame's source and destination are intra VPLS PE communication peers. Hence, VPLS PE 102 looks up the uMAC-vMAC mapping table and determines the egress port for the MAC frame. It is seen that no MAC address translation is carried out during the forwarding.

The present invention further related to an edge router for executing the method as shown in FIG. 3 and FIG. 4.

According to an embodiment, the VPLS PE 102 for example comprises a source address converting module and a message transmitting module. Upon receiving a message that includes globally unique MAC address (VM190@uMAC) of VM 190 as its source MAC address from VM 190, and IP address (VM194@IP) as its target address, the source address converting module may convert the VM190@uMAC into VM190@vMAC as its source address by looking up items in the uMAC-vMAC mapping table in Table 3. The message transmitting module transmits a message that includes a source address as VM190@vMAC to VPLS PE 103 according to the target address VM194@IP. In this process, the message is an ARP request message.

If the message is an ARP response message, the VPLS PE 103 (specifically, the source address converting module and message transmitting module included in the VPLS PE 103) executes similar steps of address conversion and message transmission, as shown by steps S303 and S304 in FIG. 3.

In this embodiment, the source address converting module may convert the source address of the message into VM190@vMAC or VM194@vMAC according to the uMAC-vMAC mapping table stored in the VPLS PE 102 or 103.

According to another embodiment of the present invention, the VPLS PE 102 (or VPLS PE 103) may include a first MAC address converting module configured to, when a first data packet containing a source address being a VM 190's globally unique MAC address and a target address being a VM 194's locally virtual MAC address VM194@vMAC from the VM 190 is received, convert the source address into a VM 190's globally unique MAC address of the VM 190; and the VPLS PE 102 (or VPLS PE 103) may include a second MAC address converting module configured to, when a second data packet containing a source address being a VM 194's locally virtual MAC address VM194@vMAC and a target address being a VM 194's locally virtual MAC address VM194@vMAC from the VM 194 is received, convert the target address of the data packet into a VM 190's globally unique MAC address of the VM 190.

Preferably, the VPLS PE 102 (or VPLS PE 103) may further include a first data output port determining module configured to determine an output port of a first data packet according to the PEID information in the virtual MAC address of the VM 194, and a second data output port determining module configured to determine an output port of a second data packet according to the PEID information in the virtual MAC address of the VM 190.

In order to convert between MAC address and virtual MAC address, the VPLS PE 102 (VPLS PE 103) correspondingly comprises a module for conversion between MAC address and virtual MAC address according to the stored uMAC-vMAC mapping table.

In an embodiment of the router according to the present invention, a module or an element may be implemented as an instruction executable by a processor or a computer for executing element functions. Certain instances of the instruction include software, program code and firmware. When it is executed by a processor, the instructions may guide the processor to execute the element function by operation. The instruction may be stored in a memory device readable by a processor. Certain instances of the memory device include a digital or solid state memory, a magnetic memory medium like a magnetic disc or a cassette, a hard disc or an optical readable digital data memory medium.

Comparing to the solution in the prior art, the present invention brings about the following advantage: the best existing solution requires the first hop switch to perform MAC address stacking/de-stacking. It means that the solution is not valid for the data centers that utilizing legacy switches. However, the proposed solution in this invention does not require changing any intermediate switches between provider's VPLS PE and virtual machines. Hence, the new solution is more economic and general. Furthermore, in the best existing solution, MAC address stacking results in additional work load on the first hop switch. However, the proposed solution does not require such stacking process. Since VPLS PE's L2 information has been jointly encoded into the virtual MAC of the destination virtual machine, the virtual MAC itself has contained the backbone MAC information and hence no more backbone MAC, such as MAC of key entities VPLS PE 102, 103 etc. in the backbone network as shown in FIG. 1, is needed.

Though specific embodiments are described hereby, the range of the present invention is not limited to these specific embodiments. The range of the present invention is defined by the following claims and any equivalent forms thereof.

1. A method for processing messages on an edge router of a virtual private LAN service (VPLS) based communication network, the edge router being interconnected with a second edge router, the edge router and the second edge router respectively providing accesses to the communication network for a first device and a second device, the method comprising:
when a message containing a MAC address of the first device as a L2 source address and an IP address of the second device as a L3 target address from the first device is received, converting the L2 source address of the message into a virtual MAC address of the first device; and
sending a message having the virtual MAC address of the first device to the second edge router according to the IP address of the second device,
wherein the virtual MAC address of the first device contains information PEID identifying the edge router, information VMID identifying the first device and information VIDCA for, in case that there may be a collision when the first device is identified, collision avoidance.

2. The method according to claim 1, wherein,
if the message is an Address Resolution Protocol (ARP) request message, the first device is a virtual machine and the second device is a virtual machine or a cloud customer device; and
if the message is an ARP response message, the first device is a virtual machine or a cloud customer device and the second device is a virtual machine.

3. The method according to claim 1, wherein, the information identifying the edge router is obtained from specific fields of network interface card of the MAC addresses of the edge router or obtained from the IP address of the edge router.

4. The method according to claim 1, further comprising converting the source address of the message into the virtual MAC address of the first device according to the uMAC-vMAC mapping table stored in the edge router.

5. A method for transmitting data packets on an edge router of a VPLS based communication network, the edge router being interconnected with a second edge router, the edge router and the second edge router respectively providing accesses to the communication network for a first device and a second device, the method comprising:
when a first data packet whose source address is a MAC address of the first device and target address is a virtual MAC address of the second device from the first device is received, converting the source address of the first data packet into a virtual MAC address of the first device; and
when a second data packet whose source address is a virtual MAC address of the second device and target address is a virtual MAC address of the first device from the second device is received, converting the target address of the second data packet into a MAC address of the first device,
wherein, the virtual MAC address of the first device contains information PEID identifying the edge router, information VMID identifying the first device and information VIDCA for, in case that there may be a collision when identifying the first device, collision avoidance, and
the virtual MAC address of the second device contains information PEID identifying the second edge router, information VMID identifying the second device and information VIDCA for, in case that there may be a collision when identifying the second device, collision avoidance.

6. The method according to claim 5, further comprising:
determining an output port of the first data packet according to the PEID information in the virtual MAC address of the second device, and
determining an output port of the second data packet according to the PEID information in the virtual MAC address of the first device.

7. The method according to claim 5, wherein, the source address of the first data packet is converted into the virtual MAC address of the first device and the target address of the second data packet into the MAC address of the first device according to the uMAC-vMAC mapping table stored in the edge router.

8. An edge router for processing a message in a VPLS based communication network, the edge router being interconnected with a second edge router, the edge router and the second edge router respectively providing accesses to the communication network for a first device and a second device, the edge router comprising:
a source address converting module configured to, when a message containing a MAC address of the first device as a L2 source address and an IP address of the second device as a L3 target address from the first device is received, convert the source address of the message into a virtual MAC address of the first device, and
a message transmitting module configured to transmit the message having the virtual MAC address of the first device to the second edge router according to the IP address of the second device,
wherein, the virtual MAC address of the first device contains information PEID identifying the edge router, information VMID identifying the first device and information VIDCA for, in case that there may be a collision when identifying the first device, collision avoidance.

9. The edge router according to claim 8, wherein,
if the message is an ARP request message, the first device is a virtual machine and the second device is a virtual machine or a cloud customer device; and
if the message is an ARP response message, the first device is a virtual machine or a cloud customer device and the second device is a virtual machine.

10. The edge router according to claim 8, wherein the information identifying the edge router is obtained from specific fields of network interface card of the MAC addresses of the edge router or obtained from the IP address of the edge router.

11. The edge router according to claim 8, wherein the source address converting module is further configured to convert the source address of the message into a virtual MAC address of the first device according to the uMAC-vMAC mapping table stored in the edge router.

12. An edge router for transmitting data packets in a VPLS based communication network, the edge router being interconnected with a second edge router, the edge router and the second edge router respectively providing accesses to the communication network for a first device and a second device, the edge router comprising:
a first MAC address converting module configured to, when a first data packet containing a source address being a MAC address of the first device and a target address being a virtual MAC address of the second device from the first device is received, convert the source address of the first data packet into a virtual MAC address of the first device, and
a second MAC address converting module configured to, when a second data packet containing a source address being a virtual MAC address of the second device and a target address being a virtual MAC address of the first device from the second device is received, convert the target address of the second data packet into a MAC address of the first device,
wherein, the virtual MAC address of the first device contains information PEID identifying the edge router, information VMID identifying the first device and information VIDCA for, in case that there may be a collision when identifying the first device, collision avoidance, and
the virtual MAC address of the second device contains information PEID identifying the second edge router, information VMID identifying the second device and information VIDCA for, in case that there may be a collision when identifying the second device, collision avoidance.

13. The edge router according to claim 12, further comprising:
a first data output port determining module configured to determine an output port of a first data packet according to the PEID information in the virtual MAC address of the second device, and
a second data output port determining module configured to determine an output port of a second data packet according to the PEID information in the virtual MAC address of the first device.

14. The edge router according to claim 12, wherein,
the first MAC address converting module is further configured to convert the source address of the first data packet into the virtual MAC address of the first device according to the uMAC-vMAC mapping table stored in the edge router, and
the second MAC address converting module is further configured to convert the target address of the second data packet into the MAC address of the first device according to the uMAC-vMAC mapping table stored in the edge router.
